(19) United States
(12) Patent Application Publication
(10) Pub. No.: US 2007/0265913 A1
(43) Pub. Date: Nov. 15, 2007

(54) Method of recruiting members to a multi-level marketing system

(76) Inventor: James Roy Brownlee, West Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/432,638

(22) Filed: May 12, 2006

(51) Int. Cl. G06Q 30/00

(52) U.S. Cl. 705/14

(57) ABSTRACT

Multi-level marketing systems have difficulty recruiting members in the preferred demographic. A method of recruiting individuals from a target demographic to become members of a multi-level marketing system, involves i) the multi-level marketing system obtaining exclusive rights to an exclusive product to which individuals in the target demographic are attracted; and ii) encouraging the individuals upon purchase of the exclusive product to register as members of the multi-level marketing system. The individuals may be required to register with the multi-level marketing system in order to purchase the exclusive product. According to a preferred embodiment, the target demographic is young mothers and the exclusive product is an ecologically friendly diaper.

### TECHNICAL FIELD

The invention related to multi-level marketing systems, and more particularly to methods of recruiting members for multi-level marketing systems.

### BACKGROUND

Multi-level marketing, sometimes also referred to as network marketing, is a method of promoting sales and distribution of products or services in which a commission or other benefit is paid or provided to the salesperson or member directly responsible for making the sale, and also to the member responsible for recruiting the salesperson who is making the sale, and also to the member who recruited that member, and so on up the recruitment chain. Thus each individual member/salesperson can profit not only from commissions on sales made by that person, but also by recruiting others as members of the system. Attracting and recruiting suitable new members is the single most difficult and important activity in creating a successful multi-level marketing system.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention therefore provides a method of recruiting individuals from a target demographic to become members of a multi-level marketing system, wherein the multi-level marketing system includes sales of a line of products or services, and provides for individuals to register as members of the system, the method comprising: i) the multi-level marketing system obtaining exclusive rights to a product to which individuals in the target demographic are attracted; and ii) encouraging the individuals upon purchase of the exclusive product to register as members of the multi-level marketing system. According to one aspect of the invention the individuals are required to register with the multi-level marketing system in order to purchase the exclusive product. According to a preferred embodiment the target demographic is young mothers and the exclusive product is an ecologically-friendly diaper.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a flowchart illustrating the method of the invention.

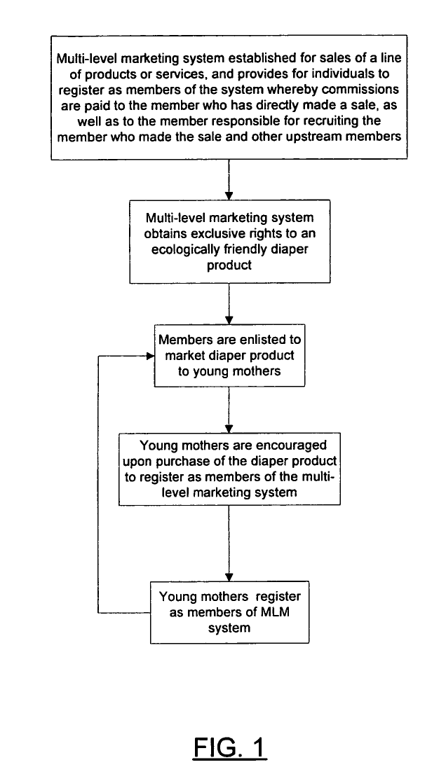

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The invention arises from the discovery that the most effective target members for certain types of multi-level marketing systems are parents, particularly mothers, with young children. Such individuals, in their early child-rearing years, are concerned with the health of their children and family and are environmentally conscious and will pay a premium for ethical, environmentally safe or healthy products in order to protect their children. Mothers at home with children also have a greater potential for operating a business out of their homes, and will often require extra income. Women are responsible for most consumer purchases and make most household financial decisions. Such individuals however are also wary and skeptical of MLM systems and profit-driven business in general and are therefore difficult to recruit.

Young parents, of child-rearing age, preferably in their 20's and 30's are ideal targets for MLM network recruiting, as they have a greater number of years of purchasing power to remain members of the MLM network than older recruits, and have a greater potential social group to themselves recruit from in future.

A diaper is a product with special interest and appeal to young mothers. It represents the loving and caring relationship between the parent and infant. It is a non-threatening and familiar product to young mothers. It is generally not associated with high-pressure marketing tactics as sometime are applied with multi-level marketing products. The vast majority of young parents, particularly mothers, utilize disposable diapers due to the inconvenience of cloth diapers. However typical disposable diapers are not recyclable and cause considerable environmental concern to the young mother, with a resultant feeling of guilt. Some environmentally friendly diaper systems are available, though often at a premium cost. An example is the present inventor's diaper system with a re-usable outer shell and replaceable absorbent insert, disclosed in International patent application no. PCT/CA97/00634, publication no. WO 99/12502 published Mar. 18, 1999 entitled “Disposable Non-Absorbent Diaper Shell With Removable and Replaceable Absorbent Pad and Method of Making Same”. Other environmentally-friendly diaper systems, for example, may be manufactured from bio-degradable plastics. An “ecologically-friendly” or “environmentally-friendly” diaper is one that either reduces the amount of material which is disposed of in waste disposal systems, re-uses portions of the diaper system, facilitates recycling of the diaper materials, or contains bio-degradable material, or any combination of those features.

The present invention involves first establishing a multi-level marketing system for sales of a suitable line of products, such as health and nutrition products, cleaning and household products and the like. The system provides for individuals to sign up and become members of the system whereby members can take orders for sales of the system's product line from purchasers, deliver such orders to the system and either deliver the purchased products from the member's inventory or from a central inventory, and which arranges a commission or other benefit, such as money, a gift, points which can be redeemed for merchandise etc. to be paid or provided to the member who has directly made the sale, as well as to the member responsible for recruiting the member who made the sale, and also to the member who recruited that member, and so on up the recruitment chain (“upstream members”), whereby each individual member/salesperson can profit not only from commissions on sales made by that person, but also from sales by members the individual recruited and those members recruited by those (“downstream members”) and so on.

Having established the MLM system, the system obtains the exclusive right to market a product which appeals particularly to the target recruit (“the exclusive product”). In the case of MLM systems which feature products such as health and nutrition products, cleaning and household products, the ideal target recruit is a mother of child-bearing age. The exclusive product which has been discovered to be of surprising effectiveness for attracting such target recruits is an ecologically-friendly diaper. Therefore the MLM system acquires exclusive rights to sell the ecologically-friendly diaper, which will be identified with an exclusive trademark, for example “ECO-SAFE diapers”, so that the target recruit will be certain of the source of the product. The existing members, who will preferably also be of the target demographic, namely young mothers, will introduce the exclusive diaper product to other young mothers through contacts at schools, clubs, daycare, playgrounds and the like. The target recruits will be attracted to the ECO-SAFE diapers due to their concern for their family health and well-being as well as the environment, and will therefore seek to purchase the product from the member of the MLM system. In order to purchase the product the MLM system may require the target recruit to register as a member with the system. In one embodiment of the invention this will be done by the target recruit ordering the product from the system's website, e.g. www.eco-safe_diapers.com, which has been provided to the target recruit by the member, such as by the member providing a business card with the web site address and the member identification number. The target is required to enter her name, address, email address and other identifying information as well as the selling member's identification number for commission purposes, which must be entered to order, and credit card information or other means of payment online. The target recruit may learn details of how the commission structure works in the MLM system from the web site. The MLM then arranges for delivery of the product from a central inventory.

In a second embodiment of the invention, the target recruit orders the product directly from the member/salesperson, who obtains the target's name, address, email address and other identifying information, and credit card information or other means of payment. The member/salesperson advises the target of how the commission structure works in the MLM system, and then either delivers the product to the target purchaser or orders the product from the MLM system for delivery to the purchaser. The MLM then arranges for delivery of the product to the purchaser from a central inventory either directly to the purchaser or through the member.

Alternatively, the target recruit need not be required to register as a member of the system in order to purchase the product but learns of the advantages of registering as a member and obtaining commissions on sales and sales by downstream recruits from the member who recruited her, or through promotional material distributed with the diaper product. Due to the nature of diaper products the target recruit will need replenishment of the product supply at regular intervals, when she again will come into contact with the member of the MLM system which is the exclusive source of the product and learn of the advantages of registering as a member of the system in order to obtain a direct supply of the product at a discount, plus potentially benefit from commissions through sales of the product or recruiting further members.

Once registered with the system, either as an obligatory step in purchasing the diaper product, or voluntarily as a result of ongoing contact with the MLM system and encouragement by the potential for discounts on the diaper and further commissions, the target will receive full catalogues and product information for the other products in the MLM systems full product line, and will be encouraged to purchase such products and/or sell such products to obtain commissions. Further, the target mother, who is now a member of the MLM system, will naturally come into contact with other mothers in similar circumstances, who in turn will be attracted to become members of the MLM system in order to purchase, or because of purchases, of the exclusive ECO-SAFE diaper product.

The invention arises from the discovery that the ecologically friendly diaper breaks down the usual resistance of the young mother to multi-level marketing (“MLM”) companies, and establishes a relationship of trust between the young mother and the MLM company. The young mother becomes receptive and willing to learn about the other products sold by the MLM company and will purchase and promote them also. Thus the exclusive product has pre-qualified the new members of the system as the most desirable demographic, without any recruitment expenditure by the MLM company. The exclusive product, such as the ecologically-friendly diaper, may be, but need not be, sold at a reduced or zero profit margin in order to further attract members, since the main benefit will be building the network of members to sell the full line of products, rather than profiting on the diaper sales. A further advantage of diapers as the exclusive product is that it is a volume consumable product which quickly builds up PV (“personal volume”) points for new members to further make the MLM system attractive.

While a number of exemplary aspects and embodiments have been discussed above, those of skill in the art will recognize certain modifications, permutations, additions and sub-combinations thereof. While ecologically friendly diapers has been found to be surprisingly effective as a exclusive product, other types of exclusive product will be suitable for other target demographics, for example a MLM system which markets insurance products, and for which the target demographic is a young father, may use a different exclusive product such as a sports-related product. It is therefore intended that the following appended claims and claims hereafter introduced are interpreted to include all such modifications, permutations, additions and sub-combinations as are within their true spirit and scope.

What is claimed is:

1. A method of recruiting individuals from a target demographic to become members of a multi-level marketing system, wherein said multi-level marketing system includes sales of a line of products or services, and provides for individuals to register as members of the system, the method comprising:
i) said multi-level marketing system obtaining exclusive rights to a product to which individuals in said target demographic are attracted; and
ii) encouraging said individuals upon purchase of said exclusive product to register as members of said multi-level marketing system.

2. The method of claim 1 wherein said individuals are required to register with said multi-level marketing system in order to purchase said exclusive product.

3. The method of claim 1 wherein said target demographic is young mothers and said exclusive product is an ecologically-friendly diaper.

4. The method of claim 2 wherein said target demographic is young mothers and said exclusive product is an ecologically-friendly diaper.

5. The method of claim 1 wherein a commission is paid to the member who has directly made a sale, as well as to the member responsible for recruiting the member who made the sale.

6. The method of claim 1 wherein a commission is paid to the member who has directly made a sale, as well as to one or more upstream members.

7. The method of claim 1 wherein a benefit is provided to the member who has directly made a sale, as well as to the member responsible for recruiting the member who made the sale.

8. The method of claim 1 wherein a benefit is provided to the member who has directly made a sale, as well as to one or more upstream members.

9. The method of claim 3 wherein a commission is paid to the member who has directly made a sale, as well as to the member responsible for recruiting the member who made the sale.

10. The method of claim 3 wherein a commission is paid to the member who has directly made a sale, as well as to one or more upstream members.

11. The method of claim 3 wherein a benefit is provided to the member who has directly made a sale, as well as to the member responsible for recruiting the member who made the sale.

12. The method of claim 3 wherein a benefit is provided to the member who has directly made a sale, as well as to one or more upstream members.

13. The method of claim 4 wherein a commission is paid to the member who has directly made a sale, as well as to the member responsible for recruiting the member who made the sale.

14. The method of claim 4 wherein a commission is paid to the member who has directly made a sale, as well as to one or more upstream members.

15. The method of claim 4 wherein a benefit is provided to the member who has directly made a sale, as well as to the member responsible for recruiting the member who made the sale.

16. The method of claim 4 wherein a benefit is provided to the member who has directly made a sale, as well as to one or more upstream members.
